(19) United States
(12) Patent Application Publication
(10) Pub. No.: US 2008/0013540 A1
(43) Pub. Date: Jan. 17, 2008

(54) System and method for selective delivery of media streams

(76) Inventor: Matthew Stuart Gast, San Francisco, CA (US)

Correspondence Address: Matthew S. Gast, 379 Capitol Avenue, San Francisco, CA, 94112, US

(21) Appl. No.: 11/484,535

(22) Filed: Jul. 11, 2006

(51) Int. Cl. H04L 12/56

(52) U.S. Cl. 370/392; 370/401

(57) ABSTRACT

A system and method for selectively delivering media streams to remote users is disclosed. In an embodiment of the present invention, the transmission of media streams to remote users is based on the time of day at remote locations. The time of day is computed from an offset from the home location and is automatically determined based on the network address of the remote user.

### FIELD OF THE INVENTION

This invention relates generally to networking systems, more specifically, to a method of selective processing of media streams based on time of day.

### BACKGROUND OF THE INVENTION

Telecommunications and network connectivity are vital tools for travelers to stay in touch with both business associates and family when away from home. Long-distance trips impose extra communications overhead because they may involve large differences in time of day between the location visited by the traveler and his or her home office.

Many communications networks, including the telephone network, the widespread GSM system for mobile telephones, and the Internet, offer the ability to deliver messages between any two points rapidly and efficiently. Many communication protocols are available over the Internet. Some of these protocols can be used to emulate traditional telephone network applications such as telephone calls or videoconferencing, while others provide text-based communications such as instant messaging (IM). However, if the time difference between two points is large, coordinating real-time communication can be difficult.

Travelers may also be disturbed unwittingly by associates and family who do not realize they are traveling. Many mobile telephones offer international roaming, which enables travelers to continue to use a “home area” telephone number regardless of location. Because many callers will assume that the traveler is relatively near to his or her home location, they will call during normal business hours at the traveler's home location. If the traveler is far from home, the call may be completed at an inconvenient or unpleasant time. For example, a call made from California to Sydney, Australia on Friday at 10:30 AM in California will be completed at 3:30 AM on Saturday in Australia.

Roaming connections made to mobile telephones that are roaming across international boundaries are typically very expensive. Telecommunications carriers typically do not offer the ability to restrict these calls because they are very profitable, and would prefer that as many as possible of these profitable calls are connected and billed. Instead, they instruct users to make changes to telephone equipment to disable and re-enable indications of incoming calls. However, many users will forget to re-enable ringing in the morning and may miss vital calls during daylight hours. In addition to the great expense of connecting calls to mobile telephones when they are roaming internationally, incoming telephone calls may be a great disturbance and interfere with the traveler's adjustment to the time change between the home location and the visited location.

Although this discussion has been presented in terms of telephone calls, it also applies to many other communications systems. Many communications systems will notify a user of an incoming session request, including videoconferencing, Web-based systems, instant messaging, and other real-time communications technologies.

This invention discloses a system and method for selectively delivering media streams to remote users based on the time in a remote location. It allows users to avoid unwanted disturbances far from home and to adjust the setup of media sessions based on business or daylight hours in the new location, with the ability to adjust media session setup on a user-configurable basis.

### BRIEF DESCRIPTION OF THE INVENTION

Most travelers will maintain a home location that serves as a connection point for most communication services. For example, most employees are based out of an office, and will arrange for Internet, telephone, and mobile telephone services from there. The “home location” is where a user is based, and the “home time” is the local time at the home location. When a traveler leaves the home location, he or she will be in a remote location. The location visited by the traveler also has a local time, which will be referred to as the “user time” or “remote time.” With traditional “fixed” telephone service, the area code is related to a geographic area, and is understood by callers to have a particular time associated with it. For example, the 415 area code is used for numbers in San Francisco, and callers to 415 numbers assumed that the person they are reaching is in the Pacific time zone of the United States.

Local times are usually expressed as an “offset” from universal coordinated time (UTC). UTC is a convenient time-keeping method because there are many protocols that can be used to automatically synchronize a computer clock to UTC, such as the Network Time Protocol (NTP). The offset is the number of hours by which the local time differs from UTC; United States Pacific Standard Time is −8 hours relative to UTC. Local time may also be adjusted by an hour for Daylight Saving Time (DST) or Summer Time. United States Pacific Daylight Time is −7 hours relative to UTC, and is observed between the first Sunday in April and the last Sunday in October.

Many network addresses have structure that enables them to be associated with a geographic area, a process called geolocation. For many telephone numbers, this process is quite simple because telephone numbers are assigned geographically. Many data networks lack such rigid geographical assignments. The Internet uses a combination of direct assignments from the Internet Assigned Numbers Authority (IANA) as well as geographic assignments through regional internet registries (RIRs) such as the American Registry for Internet Numbers (ARIN), with responsibility for North American and the Caribbean, and the RIPE Network Coordination Center, with responsibility for Europe and the Middle East. Based on the address allocation information, it is possible to build a database that ties an IP network address to a geographic location. Two representative examples are the GeoIP database from MaxMind LLC or the database maintained by the HostInfo project (http://hostip.info). Data from a geolocation database may include a variety of information about an IP address, such as a country name, latitude and longitude coordinates, or even a time zone.

Geolocation databases can be used to estimate the time zone of a traveler's remote location. When a remote user receives a network address, the remote time for that user can be estimated from network geolocation data. In some cases, the country name may be enough information to establish a time zone. Many European countries are small enough to have territory in only one time zone. Some large countries, such as China, also adopt a single time zone for the entire country. When latitude and longitude data is available, the time zone can be estimated from the longitude. Time zones are approximately 15 degrees longitude wide, with 0 degrees as the midpoint of the central time zone. For example, the Pacific time zone in the United States ranges approximately from 127.5 degrees west longitude to 112.5 degrees west longitude.

It is advantageous to maintain the time zone for the remote location for each user to offer different services at different times of day, or only accept certain services during pre-set times. One example is to only accept telephone calls during the business day, or during a broad range when they are likely to be awake. For example, users may choose to accept calls from 8 am to 6 pm in the local time at the remote location to cover the business day, or from 7 am to 10 pm to offer better times for communications with people in the home time zone. Many users will find it useful to restrict telephone calls for a meeting, so that the telephone will not ring for the next 60 minutes. A third example of time-based restriction is to allow telephone calls even though they would ordinarily not be accepted. During the initial adjustment to a very different time zone, traveling users may be awake and working during very early morning hours. A user with severe jet lag may be willing to accept calls beginning at 4 am remote site time on the first day after arriving, but only beginning at 5 am remote site time on the second day. A programmable override allows a user to accept calls when they are ready for potential interruptions. That way, a traveler could accept telephone calls early in the morning for one day only while reserving the option to specific a different time to begin accepting telephone calls on the next day.

The first step for the user is to connect to a media stream session broker which manages the setup of media sessions. The broker is responsible for keeping track of the user's location and the time at the remote location, as well as maintaining the rules for whether or not sessions can be established with the user. The broker must have a clock to keep the current time. For accuracy, it is best if the clock is synchronized to a high-quality timing source, such as a Global Positioning System (GPS) radio clock or the Network Time Protocol (NTP). In the embodiment of the present invention which is based on the handling of media streams carrying telephone calls, the session broker may be collocated with a Private Branch Exchange (PBX) telephone system at the user's home location. In this embodiment, the user will likely connect to the PBX using the Session Initiation Protocol (SIP) and transport media stream data using the Real-Time Protocol (RTP). The user's interface with the system will be a SIP device. One major type of SIP device is a telephone that uses the SIP protocol directly to interface with a PBX. A second major type of SIP device is called an analog telephone adapter (ATA), a special-purpose gateway which converts a telephone call from traditional analog telephone systems into a stream of media packets carrying digitized voice data, and optionally, video data if used with videoconferencing equipment. A third type of SIP device is a software program running on a general-purpose computer. When a SIP device connects to a PBX, it typically creates an extension in the system.

As part of the initial connection process, the media stream broker will learn the globally routable network address of the user's device at the remote location, and can estimate the time offset between the home location and user's visited location from that data. The estimate may not be completely accurate due for several reasons, including missing data in the geolocation database or errors in processing for daylight savings time. Because the estimate may be wrong, it is useful to have the user confirm the time after the registration occurs. Several well-known methods exist for confirming the time offset. One method of confirmation is to contact the user with the same means they used to register with the broker. If the user is registering with the broker to receive telephone calls, the broker can place a telephone call to the user. If the broker is available on the public Internet, there could be a required user procedure to perform a confirmation step with, for example, a web application.

Confirmation may begin by prompting the user for the time zone they are in, or alternatively, asking them to confirm the current time. If the current time is incorrect, the system can request that the user adjust the time so that it is correct. Time adjustment may occur either by correcting the time zone or offset value directly, or by giving the broker the remote location time and having it compute the offset directly. Computation of the offset directly from the local time is advantageous because it places only minimal demands on a jet-lagged traveler, who is required only to read a clock at the remote location. Some network protocols offer the ability to learn time zones directly from the network, for example through the DHCP Time Offset option that specifies the offset from UTC in seconds. There have been additional proposals to address this function in the Internet Engineering Task Force (IETF) Dynamic Host Configuration (DHC) working group. In cases where the user device at the remote location learns a time zone, it can report that to the media broker for direct use in estimating the time at the remote location.

After the time zone offset for the remote location is confirmed, it is stored by the broker so that the broker can calculate the remote time. It is advantageous for the offset to be stored with an expiration date and the remote network address for the user's device so that the offset value and special handling can stop when it is no longer needed. When travelers know the duration of their stay at the remote location, they can configure an expiration date for the remote time offset. Expiration dates allow call handling exceptions to revert to the normal time when a trip ends. By storing the network address, it is possible to determine if the user is changing locations. As long as the user location is not changing, there is no need to reconfirm the remote time.

When a request comes in to initiate a media stream, the broker first checks to see if the destination is available. If a destination is available, the call can be checked against the list of time periods for special handling. An incoming request received during business hours or during a period in which calls are being accepted can be dispatched immediately to the remote user's device. This may or may not include the broker handling the media stream. Some protocols may require that the broker proxy every packet of the media stream, while others allow the broker to connect the two endpoints of the stream while remaining out of the data path. If the request occurs when the user is not to be disturbed, the media stream is not allowed to connect, or redirected to an alternate location for processing.

In an embodiment of the invention used to handle telephone calls where the broker is resident on a PBX, it may be desired to ring multiple extensions if the user has several points of presence. Extensions can either ring simultaneously, or in sequence. Ringing simultaneously allows a user to be reached at multiple physical locations. During simultaneous ringing, handling of the local time at the extension may require that it be removed from the ringing list. Ringing multiple extensions in sequence allows the telephone system to compare time at each extension to the user's preference, and maximizes the ability to place a call to a traveler. It also optionally allows a caller to redirect a telephone call to the user's mobile phone. Although this may be quite expensive, especially if the user is beyond the coverage area included with their mobile phone plan, it may be desired for certain callers or at certain times of day.

Selective call placement may be accomplished by different routing of the call itself, or by changing the telephone ring. Routing of the call is accomplished by connecting it to a different destination, such as a voice mail system. Changing the telephone ring has certain advantages, however. Many telephones have the ability to offer distinctive rings. A common implementation allows configuration of the “ring cadence” into “on” periods and “off” periods. The United States ring standard is a half-second ring followed by a half-second of silence. On many devices, ring cadences are configurable, so it is possible to configure the ring cadence for 60 seconds of silence. By configuring for a silent ring, referred to in this disclosure as “ring suppression,” the telephone extension will be “live” and ready to take a call during its silent ring, though there will be no audible indication. This has the advantage that if a user has a device that can offer a silent but visual indication of an incoming call, it can still be answered based on caller identification. An example would be a telephone with caller ID capable of silent ringing, or the MythPhone application. MythPhone is a software telephone that integrates with the MythTV personal video recorder (PVR). If a telephone call is placed to a running instance of MythPhone while the PVR user is watching a program, it will present the caller ID information.

It is also possible to offer different services to different callers. The caller identification can be based on identification from the telephone network such as automatic number identification (ANI) or CallerID. In the case of calls made directly to the telephone system over the data network, it may also be based on information from the data network. In the case of an Internet Protocol (IP) network, that may be the IP address or Domain Name Service (DNS) name. Callers who have registered telephone network numbers may also be processed according to lookups of their addresses in a public telephone number (or E.164) mapping to IP address stored in the DNS.

One example of different service levels for different callers is an “override” feature that allows the caller to place a call even during the suppression period. That way, pre-approved callers such as friends, family, or supervisor may place calls even during the ring suppression period. Because the telephone system maintains both the time at the traveler's home location as well as the remote location, it is convenient to inform the caller automatically of the remote time and ask for confirmation before completing the call. It is also possibly to optionally offer a service to callers that provides the remote time of a user without disturbing them.

### BRIEF DESCRIPTION OF THE DRAWINGS

FIG. 1 is a flow chart that illustrates the method by which a user's time offset is configured in accordance with an embodiment of the present invention.

FIG. 2 is a flow chart that illustrates the method of handling media streams in accordance with an embodiment of the present invention.

FIG. 3 is a representative diagram of the system and related components for an embodiment of the present invention.

### DETAILED DESCRIPTION

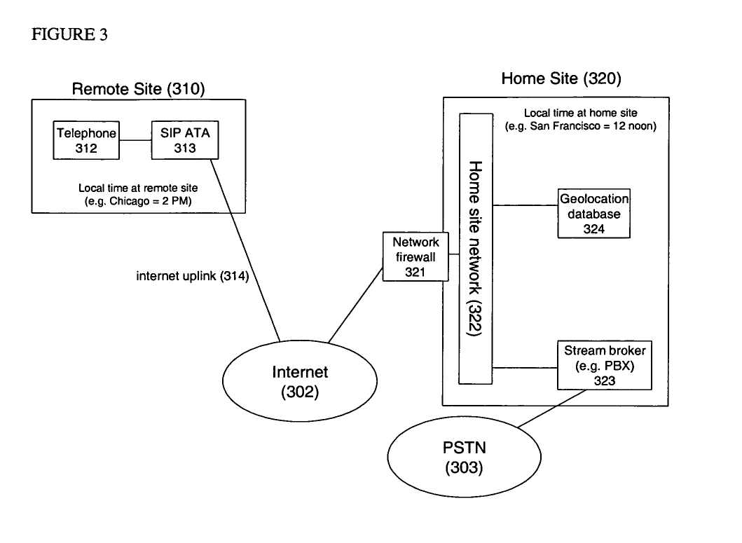

In one embodiment of the invention, shown in FIG. 3, the traveler connects to the Internet 302 at a remote location 310. For illustrative purposes, the remote location 310 is labeled “Chicago,” with a time of 2 PM. FIG. 3 shows the user connecting a telephone 312 to an analog telephone adapter (ATA) 313. Many ATAs use the Session Initiation Protocol (SIP) to register with a media stream broker that is part of a telephone system, such as a PBX 323. Other connection types are possible instead of the telephone 312 and ATA 313 combination, such as a telephone incorporating the SIP functions, or a “soft phone” program executing on a host operating system on a computer.

Many ATAs further have the ability to configure a plurality of “ring cadences” that describe the telephone ring tone in terms of the pitch, duration, and spacing of the ring emitted by a telephone. In some configurations, it is possible to configure a ring cadence that is silent. Other client devices are possible, such as a laptop computer, video phone, or even television. One of a plurality of ring cadences can be selected when a media stream is delivered to an ATA and can be set on a call-by-call basis.

When a device is connected to the Internet 302, the Internet service provider will use a globally routable IP address for the remote location on the link 314. That address is given to the Internet service provider by regional Internet registries such as ARIN or RIPE, and further registered with many databases that link the globally routable address to an organization. Several companies sell “geolocation databases” 324 that enable programs to estimate geographic location from a globally routable IP address. Geolocation databases 324 are also made available by volunteers. The geolocation database 324 maps a globally routable IP address into geographic information, comprising a number of features including country, latitude, longitude, and time zone. Not all databases have complete information for every address, and the time zone must be estimated from some of the information present, such as longitude.

At the home site 320, there is a network 322 with several components. For illustrative purposes, the home site 320 is shown as being located in San Francisco. If the time is 2 PM in Chicago, in San Francisco it will be 12 noon. If the home site is connected to the Internet 302, good security engineering practices require the use of a network firewall 321. Network firewalls are not required, but are often used to protect devices attached to the internal network 322 from attack. The network firewall 321 typically must be configured to allow media protocols to establish network connections to the broker 323 because most network firewalls 321 are configured to deny incoming connections by default. The broker 323 is responsible for maintaining relationships with a plurality of client devices. When incoming media streams are detected for these clients, the broker 323, depicted as resident within a PBX system, is responsible for locating them and helping the source of the media establish these connections. In the case of one common type of broker, a Private Branch Exchange (PBX) telephone system, the broker will also be connected to the public switched telephone network (PSTN) 303. PBXes connected to both the Internet and the PSTN may make use of E.164 DNS mappings to connect to telephone addresses over both the PSTN and Internet. Brokers may also be connected to other networks, such as an IP multicast backbone for IPTV, or instant messaging networks.

In an embodiment of the present invention, the geographic location of remote clients is retrieved from a geolocation database 324. This database maps network addresses, such as IP addresses from the Internet 302 to geographic locations. For an IP address, it may report city, state, country, latitude, longitude, and time zone. Time zone can be estimated from longitude by assuming that each time zone is approximately 15 degrees wide, with zero degrees longitude at the center of the Greenwich Mean Time zone.

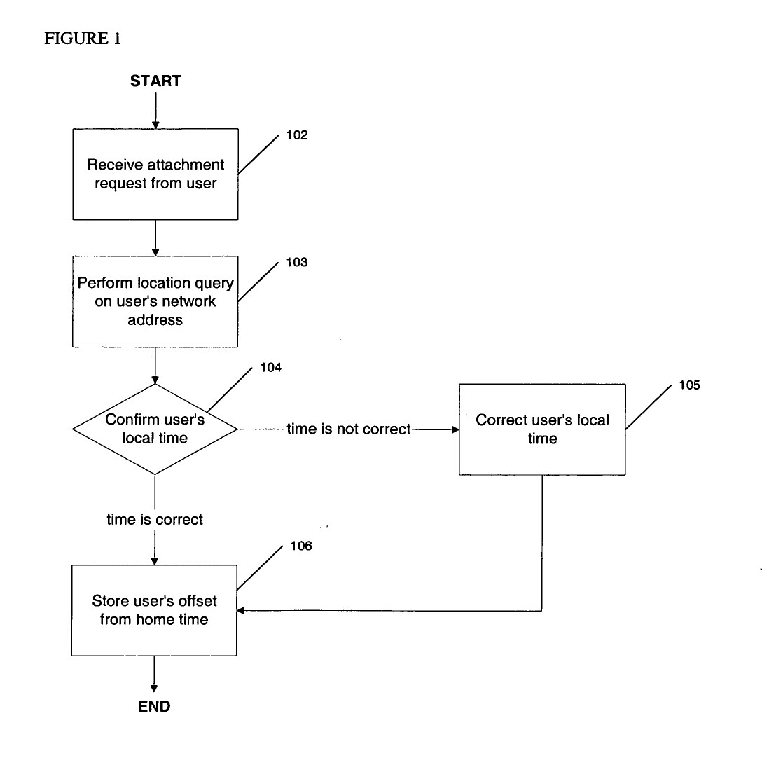

FIG. 1 illustrates the method by which a remote user's connection is set up. When a telephone device 313 is powered up, it will attempt to attach to a broker that keeps track of its network location. In step 102, the request made by the “user agent” such as an ATA 313 is received by the broker. In step 103, a program executing on the broker will receive the request, which will come from a globally routable network address. That request may include the remote time zone, as learned from the network, or the broker may need to estimate the remote time zone from other sources, such as a geolocation database. This may be done either through a database that includes time zone information for network addresses, or by some other method. Other methods include estimating the longitude of the network address and converting that to a time zone. In step 104, the broker attempts to confirm the local time at the remote user's location. In an embodiment of the invention used for telephone calls, the broker may confirm the user's time by placing a telephone call to the remote user asking them to confirm the time. The broker may also rely on the user to access a menu-driven system available through a web browser, or require that the user run a program which prompts the user for local time. If the time is not correct, in step 105, the broker must learn the user's local time. This can be accomplished by using the same communication method as was used to confirm the time, such as by continuing the telephone call or presenting additional queries thorough the interface. Once the correct time for the user has been established, the offset for the remote user's time from the home location time can be saved in step 106. The time difference may be saved either as an offset from the system's home time, or more preferably, as an offset from UTC. The remote location's offset from UTC can be easily combined with the home location's offset from UTC to learn the time difference between the local and remote locations. For example, a home location in California is known to be at UTC-8. Rather than save the time zone difference between California and Chicago as +2, it may be advantageous to compare the known values for Chicago (UTC-6) and California (UTC-8) to derive the same value.

In the case of using a telephone call in step 104, the telephone call initiated from the home site to the remote device will not be disruptive because the call can be initiated immediately following the attachment to the network. Because the user is likely already working with the telephone 312 at the remote site 310, the telephone call will not be disruptive even if it is an inconvenient time of day. Many PBXes have the ability to develop custom voice menus, and they can be interfaced with the broker software to develop user input/output routines that can connect a user to a custom-defined voice menu to confirm the time.

With the Session Initiation Protocol, devices must re-register periodically. It is important that the confirmation request is initiated only on the first registration from an address. Many devices re-register every hour, and it would be very disruptive to initiate hourly telephone calls if the device stays within the same time zone, especially if the registration confirmation uses a telephone call placed to the user. To reduce the number of remote time zone offset configuration calls initiated by the system, each time zone offset record can be saved with an expiration date, configured as part of the confirmation initiated in step 104. As long as the globally routable network address does not change, repeated registrations before the expiration date will not cause additional setup telephone calls.

As part of the remote time confirmation call, it may be helpful to offer two types of corrections in step 105. In the first type of correction, the user is prompted to correct the time by a single hour. The reason for this simpler type of correction limited to moving the time by only an hour is to account for any changes due to Daylight Saving (or Summer) Time, which is specific to every country. Many tropical countries do not keep Daylight Saving Time because the length of the day does not vary. Although not tropical, Japan also does not adjust time of day in the year. Countries in different hemispheres at the same longitude may also have different offsets because daylight time is typically kept in the summer. When it is Daylight Saving time in the United States in the northern hemisphere, it will be winter in South America.

The major service offered by this invention is suppressing disturbances from the delivery of unwanted media streams. Media streams typically consist of audiovisual information, and may cause the client device to make noise or display bright pictures. If the time difference between the home site 320 and the remote site 310 is quite large, media sessions initiated at mid-day in the home site 320 may start in the middle of the night at the remote site 310.

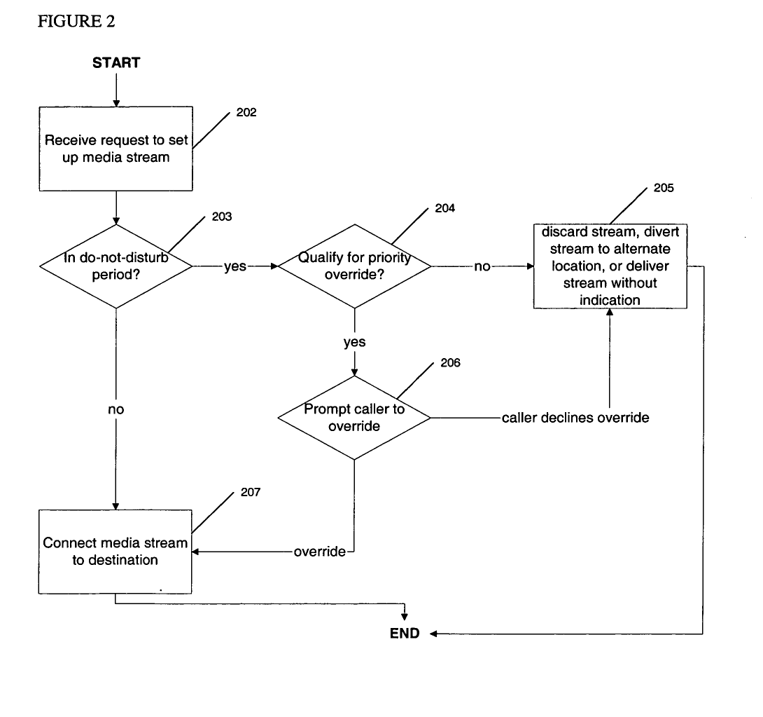

FIG. 2 shows the method of handling media streams made possible by this invention. The objective of this process is to avoid disruption to the user at the remote site. In step 202, a request is received from an initiator. The initiator may be located on any network connected to the broker. As an example, the initiator may be a telephone caller connected to the PSTN, or an instant message. However, initiators may use any protocol to establish connections to remote users.

In addition to the time zone offset, the broker 323 maintains a set of “do not disturb” periods during which media streams are prevented from bothering the user. In step 203, the broker checks the incoming request against the do not disturb periods in effect for the remote user. The most common way of implementing a do not disturb feature is to prevent delivery of media streams to the remote device. That is, the broker 323 will send a message indicating that the session cannot be established or that it should instead be redirected to another location, such as voice mail. Even if a session cannot be connected, it may be advantageous to indicate to an initiator that the broker is attempting to make a connection. If the media stream is a telephone call, it may be more acceptable to indicate to the initiator that the broker is ringing the line, even if there is no audible ring tone at the remote site. There may also be advantages from connecting the media stream without indication at the far end. If the broker connects a telephone call with a silent ring, the telephone at the remote site is “live” and the user can pick up if for some reason the user learns about the call. Multiple methods of implementing the do-not-disturb feature can be implemented on the same broker.

One common configuration for do-not-disturb periods will be to restrict incoming media streams to the normal business day, such as 8 am to 6 pm in the local time at the visited location. In the best implementation, the “normal business hours” should be configurable by the remote user, since large time offsets may require increase flexibility in accepting calls from business associates at the home location. Normal business hours are adjusted to local time through the offset from UTC; for example, a normal business day of 8 am to 6 pm at the remote location may correspond from 5 pm to 9 am in the home location.

Do-not-disturb periods can also be configured on an on-demand basis. If a user is performing a high-priority task, it may be advantageous to temporarily enter a do-not-disturb period for a fixed period of time, such as the next hour. In the early days of long trips, travelers may also choose to enable calls to be placed during non-business hours when they are nonetheless awake.

An incoming media session which is initiated when a do-not-disturb period is not active can be connected immediately in step 207, according to the rules of the protocols used to describe, establish, and transmit the media stream.

Even when a do-not disturb period is active, there may be certain initiators for whom the remote user wishes to allow through. In step 204, the initiator is checked against one or a plurality of priority overrides. Initiators that do not meet any priority rules are processed in step 205 and have incoming streams discarded, delivered to an alternate location, or silently delivered. Diversion to an alternate location may include voice mail for telephone calls. Delivery without indication can be used by performing ring suppression with a telephone call so that the line is active but there is no ring.

Overrides may allow an initiator to override the blocking of media stream delivery in step 206. In an illustrative example, a traveler may wish to allow wider latitude for incoming calls from family or friends. An example of selective handling is that prior to connecting a family member, the telephone system will prompt the caller with the local time before completing the call. For example, a caller might hear a voice prompt of the form, “The current time at the remote location is 3:30 am. Press star to complete the call, or hold for voice mail.” Such a feature allows an initiator to exercise judgment in determining the relative importance completing a telephone call at that time. To assist callers, the telephone system may also create an extension which reports the time at the remote location to callers.

The Session Initiation Protocol separates the set up of a media stream from the delivery of the actual stream. It is possible, and in fact, common for two SIP devices to set up a stream through multiple hops, but to have the media packets delivered directly between the two endpoints. However, in some situations, SIP devices will also handle delivery of media packets.

In accordance with various embodiments of the present invention, the following references may be when selecting various implementation details and are incorporated herein by reference: the Internet Protocol (RFC 791), the Transmission Control Protocol (RFC 793), the User Datagram Protocol (RFC 768), the Domain Name System protocol (RFC 1035), the Network Time Protocol (RFC 1035), the Session Initiation Protocol (RFC 3261), the Session Description Protocol (RFC 2327), the Real-Time Protocol (RFC 3550), the Network Time Protocol (RFC 1305), and the Dynamic Host Configuration Protocol (RFC 2131).

While the invention has been described with respect to exemplary embodiments, one skilled in the art will recognize that numerous modifications are possible. For example, the processes described herein may be implemented using hardware components, software components, and/or any combination thereof. Thus, although the invention has been described with respect to exemplary embodiments, it will be appreciated that the invention is intended to cover all modifications and equivalents within the scope of the following claims.

I claim:

1. A method for handling media streams, comprising a series of packets, said method comprising:
a. Receiving a description of the stream on a broker device,
b. Determining if the destination of the stream is accepting connections, and
c. Sending the stream description to either its destination, a plurality of destinations, or an alternate location, depending on the preferences established for the destination.

2. The method of claim 1, wherein the media stream is a telephone call.

3. The method of claim 2, wherein the alternate location for delivery of the media stream is a voice mail system.

4. The method of claim 1, wherein the media stream description is transmitted using the Session Description Protocol.

5. The method of claim 1, wherein the step of sending the stream destination is carried out by using the Session Initiation Protocol.

6. The method of claim 1, wherein the broker device further processes the packets of the media stream.

7. The method of claim 6, wherein the media stream is transmitted using the Real-Time Protocol.

8. The method of claim 1, wherein the determination of whether a destination is accepting media streams is further comprised of one or more of the following:
a. Checking the current time against a defined period of time to suppress media stream delivery;
b. Checking the current time against defined time of day to enable media stream delivery; and
c. Checking the current time against one or a plurality of do not disturb periods.

9. The method of claim 8, wherein the time of day can be expressed in the local time at the remote site, said remote time being determined by a time offset from a specific location.

10. The method of claim 9, wherein the time offset is automatically determined from the network address of the remote user.

11. The method of claim 9, wherein the time offset is determined from the time zone reported by the media stream receiver.

12. The method of claim 9, wherein the time offset is confirmed by the user to set up the remote user parameters in said broker device.

13. The method of claim 12, wherein the confirmation step is carried out by a telephone call initiated from the broker to the user.

14. The method of claim 12, wherein the setup is automatically initiated when the remote device initially connects to the broker.

15. The method of claim 10, wherein the user's network address is an Internet Protocol address.

16. The method of claim 8, wherein a do-not-disturb period exists only for a fixed period of time and then expires.

17. The method of claim 1, wherein a do-not-disturb period may be overridden by specific stream initiators.

18. The method of claim 17, wherein the initiators are identified by Caller ID.

19. The method of claim 17, wherein the initiator is given the local time at the remote site before asking to confirm the override.

20. A system for handling media streams, comprising:
a. A media stream broker, with connections to one or a plurality of networks, and a clock;
b. A data store holding remote locations for a plurality of remote users, enabling computation of local time for each remote user, and
c. Means for remote users to configure whether or not they will accept delivery of media streams.

21. The system of claim 20, further comprising a network interface to a database that maps network addresses into geographic locations,

22. The system of claim 20, further comprising a database for looking up the geographic location of IP addresses.

23. The system of claim 20, where the media stream terminator further comprises interfaces for sending and receiving telephone calls.
